(19) United States
(12) Patent Application Publication
(10) Pub. No.: US 2005/0271494 A1
(43) Pub. Date: Dec. 8, 2005

(54) Anti-rotation spring clip

(75) Inventors: Mario A. Hidalgo, Phoenix, AZ (US); John P. McMahon, Phoenix, AZ (US); Robert G. Dale, Chandler, AZ (US)

Correspondence Address: Honeywell International, Inc., Law Dept. AB2, P.O. Box 2245, Morristown, NJ, 07962-9806, US

(73) Assignee: Honeywell International Inc., Morristown, NJ (US)

(21) Appl. No.: 10/860,528

(22) Filed: Jun. 2, 2004

(51) Int. Cl. F16B 39/10

(52) U.S. Cl. 411/121

(57) ABSTRACT

The present invention provides a method and apparatus for preventing rotation of a fastener, such as a nut, bolt or plug, to ensure that a threaded connection remains tightened. An anti-rotation spring clip includes a first arm and a second arm integrally connected by an expansion portion. An aperture in the second arm may hover around a fastener, such as a polygonal threaded fastener, and the first arm may have prongs for clamping around the outer surface of a tubular member. The anti-rotation spring clip is reusable and removable, has a long service life, and does not require special tools or permanent deformation for installation or use.

### BACKGROUND OF THE INVENTION

The present invention relates generally to an apparatus and a method for preventing unintended rotation of a fastener and, more specifically, to a method and apparatus for retaining an oil drain plug.

In many machinery applications, the need exists to prevent a threaded fastener, such as a bolt, nut, or plug, from backing out of its seated tightened position. External forces, for example, machine vibrations, may cause a threaded bolt, nut, or plug to back out of its seated tightened position. The loss of a bolt, nut, or plug can lead to structural integrity problems or leakage, depending on the application. Past solutions to this problem have included deformed threads or thread inserts that provide resistance to loosening, chemicals that glue the threaded features together, locking washers that provide additional friction to resist loosening, or external features, such as a lockwire or tabbed washers, which require permanent deformation to hold the bolt, nut, or plug in place.

Another approach is disclosed in U.S. Pat. No. 5,820,168 to De Giacomoni. A fastener device is used for holding a flexible hose and rigid tube assembly to a support plate. A rider has a first fork with two branches that define an internal outline designed to cooperate with a polygonal nut on a junction member. The fastener device holds the nut to prevent the nut from rotating. A second fork with two branches is placed astride an extension portion of the junction member. The two branches of the second fork are bent to bear both against the opposite face of the support plate and against a terminal shoulder of the extension portion. The junction member is urged against the stop face of the support plate to prevent translation of the junction member.

The device in the De Giacomoni reference may be used for fastening to a plate, but not a cylindrical or tubular member. The De Giacomoni reference only discloses fastening to a plate when a terminal shoulder is available near the fastening device and along the length of a tube. Preventing rotation depends upon pushing against a straight edge of the plate in combination with a stepped or notched fork. The De Giacomoni reference does not disclose a method or apparatus for preventing rotation without the use of a plate and a terminal shoulder.

As can be seen, there is a need for an improved apparatus and method for preventing rotation of a fastener to ensure that a threaded connection remains tightened without interfering with the seal between a threaded fastener, such as a bolt, nut, or plug, and its seated tightened position, and providing ease of maintenance without full removal of the apparatus. Furthermore, there is a need for an apparatus and method for preventing rotation of a fastener without using a plate or a terminal shoulder.

### SUMMARY OF THE INVENTION

In one aspect of the present invention, an anti-rotation apparatus comprises a tubular member with an outer surface and an inner surface; a fastener mated with the tubular member; a tab protruding radially outward from the tubular member; a spring clip including a first arm and a second arm; the first arm including at least one prong; the second arm having an aperture; the aperture hovering around the threaded fastener; and the first arm and second arm connected together by an expansion portion.

In an alternative aspect of the present invention, an anti-rotation apparatus comprises a tubular member with an outer surface and an inner surface; a threaded fastener mated with the tubular member; a tab protruding radially outward from the tubular member; a spring clip including a first arm and a second arm; the first arm including at least one prong and a recess; the second arm having an aperture; the aperture hovering around the threaded fastener; the recess mating with the tab; the first arm clamping around at least a portion of the outer surface of the tubular member; and the first arm and second arm connected together by an integral expansion portion. The threaded fastener may be a bolt, nut, plug, and the like.

In another aspect of the present invention, an anti-rotation apparatus comprises a tubular member with an outer surface and an inner surface; a threaded fastener mated with the tubular member; a seat situated coaxially on the outer surface of the tubular member; a tab protruding radially outward from the tubular member; a spring clip including a first arm and a second arm; the first arm including at least one prong; the second arm having an aperture, the aperture including at least one notch; the aperture hovering around the threaded fastener; the at least one prong clamping around at least a portion of the outer surface of the tubular member; and the first arm and second arm connected together by an expansion portion.

In yet another aspect of the present invention, an anti-rotation apparatus comprises a tubular member with an outer surface and an inner surface; a threaded fastener mated with the tubular member; a tab protruding radially outward from the tubular member; a spring clip including a first arm and a second arm; the first arm including two prongs; the second arm having an aperture; the aperture hovering around the threaded fastener; the two prongs touching opposite sides of the tab; and the first arm and second arm connected together by an expansion portion.

In a further aspect of the present invention, an anti-rotation apparatus for preventing rotation of an oil drain plug comprises an oil drain boss with an outer surface and an inner surface; a hexagonal threaded nut mated with the oil drain boss; a seat situated coaxially on the oil drain boss; a tab protruding radially outward from the oil drain boss; a spring clip comprised of spring steel; the spring clip including a first arm and a second arm; the first arm including at least one prong and a recess; the second arm having an aperture, the aperture including at least one notch; the aperture hovering around the hexagonal threaded nut; the recess mating with the tab; the first arm clamping to the tab and around at least a portion of the outer surface of the boss; and the first arm and second arm connected together by an integral expansion portion.

In a still further aspect of the present invention, a method of making an anti-rotation spring clip comprises providing a flat blank of resilient material having a first surface and an opposite second surface; stamping the blank to form a first arm, second arm, and an expansion portion interconnecting the first arm and the second arm; providing an aperture in the second arm; and stamping a portion of the first arm to form a plurality of prongs; bending the expansion portion such that the first arm and the second arm are coaxial about a common axis; and bending the expansion portion into a curvilinear shape.

In a yet further aspect of the present invention, a method of preventing rotation of a threaded fastener comprises providing a first arm to clamp around an outer surface of a tubular member; mating a recess in the first arm with a tab that projects radially outward from the tubular member; providing a second arm; providing an aperture in the second arm, the aperture larger than the outer dimensions of a threaded fastener; and providing an expansion portion that integrally connects the first arm with the second arm.

In a still further aspect of the present invention, a method of preventing the rotation of a threaded fastener threaded into a tubular member comprises disposing a spring clip around the threaded fastener, wherein the spring clip includes a first arm and a second arm, the first arm including at least one prong, the second arm having an aperture, the aperture hovering around the threaded fastener, and the first arm and second arm connected together by an expansion portion, applying an external force to the threaded fastener, the external force having a tendency to unthread the threaded fastener; wherein at least one corner or side of the threaded fastener abuts against the aperture, thereby preventing rotation of the threaded fastener from the tubular member.

These and other features, aspects and advantages of the present invention will become better understood with reference to the following drawings, description and claims.

### BRIEF DESCRIPTION OF THE DRAWINGS

FIG. 1 is a perspective view of an anti-rotation spring clip, according to an embodiment of the present invention;

FIG. 2 is a perspective view of the anti-rotation spring clip of FIG. 1, installed onto a drain plug, according to an embodiment of the present invention;

FIG. 3 is another perspective view of the anti-rotation spring clip of FIG. 1, installed onto a drain plug, according to an embodiment of the present invention;

FIG. 4 is a side view of the anti-rotation spring clip of FIG. 1 installed onto the drain plug of FIGS. 2 and 3, according to an embodiment of the present invention;

FIG. 5 is a perspective view of an anti-rotation spring clip, according to another embodiment of the present invention;

FIG. 6 is a perspective view of an anti-rotation spring clip, according to yet another embodiment of the present invention;

FIG. 7 is a side view of an anti-rotation spring clip, installed onto a drain plug according to still another embodiment of the present invention;

FIG. 8 is a perspective view of an anti-rotation spring clip, according to still another embodiment of the present invention;

FIG. 9 is a perspective view of an anti-rotation spring clip, according to still yet another embodiment of the present invention;

FIG. 10 is a perspective view of an anti-rotation spring clip, installed onto a drain plug according to an embodiment of the present invention depicted in FIG. 8; and

FIG. 11 is a perspective view of an anti-rotation spring clip, installed onto a drain plug according to a further embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention may be useful for an aircraft engine oil tank and other similar apparatus. Specifically, the invention may be useful for keeping fasteners such as bolts, nuts, or plugs, from loosening from a tightened position. The invention may be useful because external forces, for example, machine vibrations, may cause a threaded bolt, nut, or plug to back out of its seated tightened position. For illustrative purposes, the following description of the present invention is of an oil drain boss with a hexagonal nut. However, it is to be understood that other applications can be substituted for the oil drain boss, such as fasteners, connectors, and other similar apparatus. Further, although the nut is shown with a hexagonal shape, it should be understood that the invention is not limited to fastening an oil drain boss with a hexagonal shaped fastener (for example, a bolt, nut, or plug), and is applicable to other known types of fasteners, with other shapes (not shown herein) providing that the apparatus have a polygonal element analogous to a nut.

The present invention may provide a simple locking feature to prevent a bolt, nut, or plug from rotating out during engine operation. The present invention may facilitate easy access for removal and/or insertion of the bolt, nut, or plug. Traditional locking features, such as bending tabs, lockwires, and locking threads, require excessive labor to remove, repair, and replace, while the present invention may be easily replaceable without permanent deformation of any parts. Overhauling a turbine engine may require time-consuming removal of traditional locking features when removing the bolt, nut, or plug. In contrast, the locking feature of the present invention may be easily removed without requiring time-consuming removal of traditional locking features when removing the bolt, nut, or plug. The locking feature of the present invention may be subsequently replaced. The locking feature of the present invention may be easily removed without removing the bolt, nut, or plug for further service, for example, when removing a damaged locking feature to examine the bolt, nut, or plug for further damage.

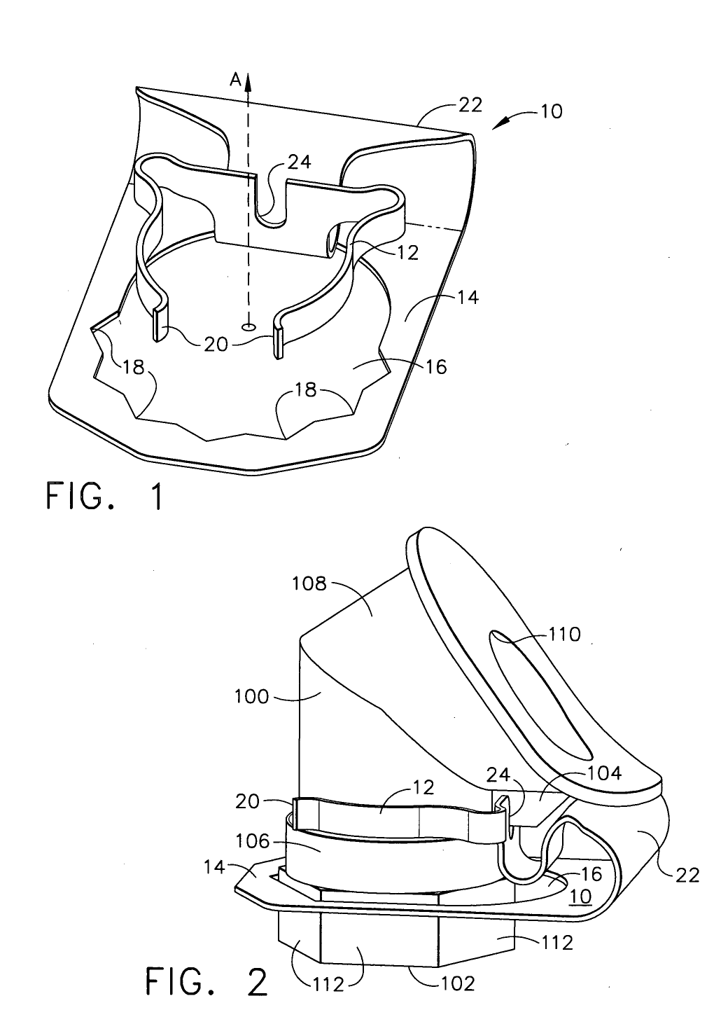

In more specifically describing the present invention, and as can be appreciated from FIG. 1, the present invention provides a spring clip 10. The spring clip 10 may be composed of any material suitable for resilient clamping, for example, spring steel. The spring clip 10 may include a first arm 12 and a second arm 14, both of which may be coaxial about a common axis A, located vertically in the middle of the spring clip 10. An expansion portion 22 may connect the first arm 12 and the second arm 14. The first arm 12 may have at least one prong 20 and in some instances, two prongs 20. The second arm 14 may have an aperture 16, which optionally may contain a notch 18, in some instances a plurality of notches 18. A recess 24 may be situated between two prongs 20.

Referring to FIG. 2, the spring clip 10 is shown as installed onto a tubular member 100, such as an oil drain boss 100, with an outer surface 108 and an inner surface 110. A fastener 102 may be inserted and mated with the tubular member 100. The fastener 102 may have a hexagonal shape and may be threaded with the boss inner surface 110. A tab 104 having, for example, a trapezoidal shape (or a rectangular shape), may protrude radially outward from the tubular member 100. The aperture 16 in the second arm 14 may hover around the fastener 102. The aperture 16 hovers around the fastener 102 in that the second arm 14 is located in close proximity to the outer surface of the fastener 102, but does not necessarily contact the outer surface of the fastener 102. The notches 18 (shown in FIG. 1) in the aperture 16 may mate with the sides 112 of the fastener 102 to restrict rotation of the fastener 102 by cooperating with the polygonal shape of the fastener 102. Any tendency of the fastener 102 to rotate may have the effect of transmitting torque to the second arm 14, which torque may be opposed by the expansion portion 22 and the recess 24, which may be mated with the tab 104. Because of the aperture 16 hovering around the fastener 102 and the optional notches 18, inadvertent rotation of the nut may be restricted.

First arm 12 may rest upon a seat 106, which may be an integral protrusion upon the boss 100. The seat 106 may be coaxial with the boss 100. Prongs 20 of the first arm 12 may clamp around the boss outer surface 108 to retain the position of the spring clip 10. Additionally, the spring clip 10 may be held in position by the recess 24 mating with both sides of the tab 104 to prevent rotation of the spring clip 10.

The spring clip 10 may be disengaged by pushing upwards on the second arm 14, towards boss 100, until the second arm 14 clears the head of fastener 102, and holding the second arm 14 in that position. At that time, the fastener 102 may be removed via normal means of removing a fastener. After the fastener 102 has been removed, the force on the second arm 14 may be backed off, returning the second arm 14 to a normal resting position. Installation of the fastener 102 may take place in the same manner as removal, for example, by first applying an upwards force to the second arm 14 until the second arm 14 clears the bottom of seat 106. The fastener 102 may then be threaded in, followed by removing the force on the second arm 14 to bring the second arm 14 to the normal resting engaged position, thus locking the fastener 102 in place.

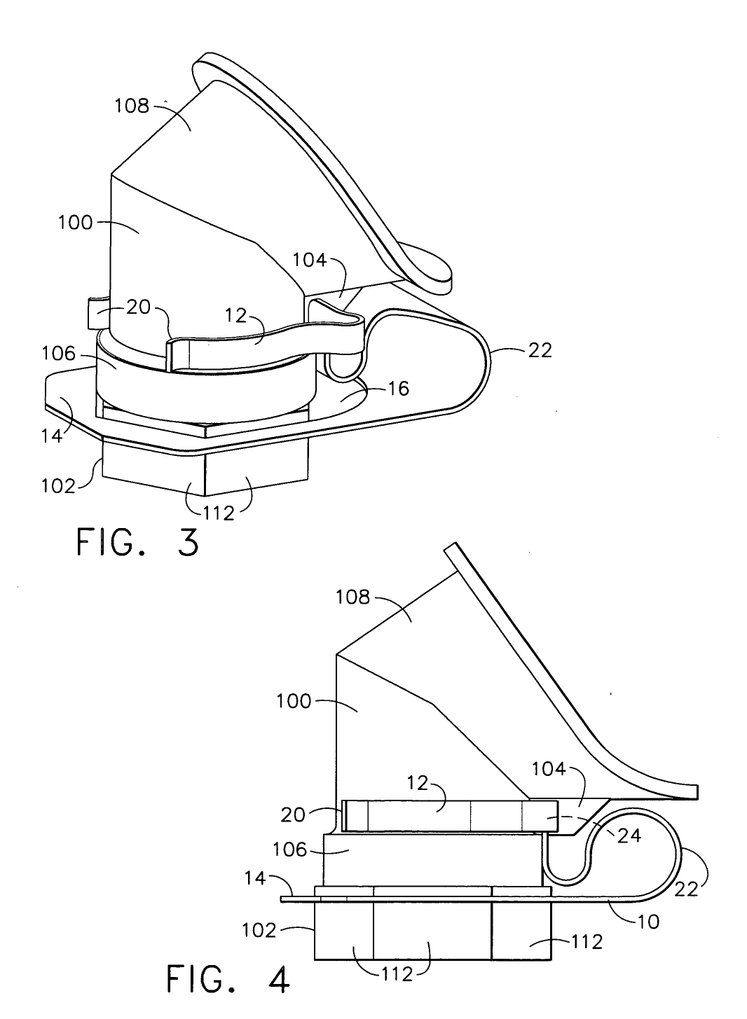

In FIGS. 3, and 4, additional views are shown of how the spring clip 10 may be attached to the boss 100 for preventing rotation of the fastener 102. The first arm 12 may locate against the tab 104, for anti-rotation of the fastener 102, and clamp around at least a portion of the outer surface 108 of the boss 100.

The benefit of the expansion portion 22 may be specifically shown in FIG. 4. An optional curvilinear shape of the expansion portion 22 may serve to firmly clamp first arm 12 above the seat 106 and to firmly clamp the second arm 14 so that the second arm 14 hovers around the fastener 102. The expansion portion 22 may serve to resiliently support the recess 24 to mate with the tab 104 for positioning the spring clip 10. The expansion portion 22 may also serve as a spring to provide resistance and spring-back force for times when arm 14 is pushed upward towards boss 100 and out of the way of fastener 102 for installation or removal of the fastener 102.

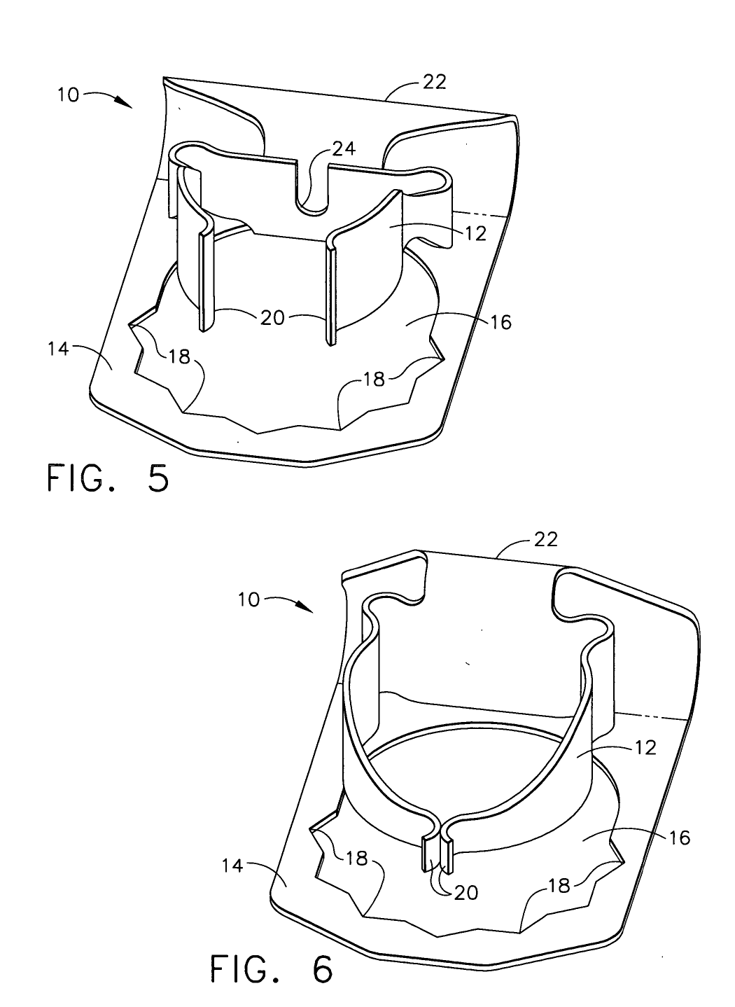

Other embodiments of the present invention are shown in FIG. 5, where the prongs 20 may be wider than the prongs 20 in FIGS. 1-4. More embodiments of the present invention are shown in FIG. 6, where the distal ends of the prongs 20 may meet, or come close to meeting, as opposed to the distal ends of the prongs 20 being separated as shown in FIGS. 1-4.

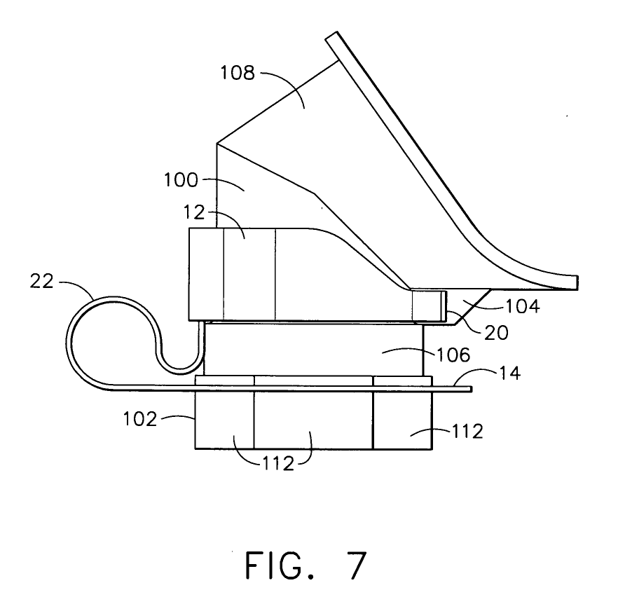

The spring clip 10 shown in FIG. 6 may be used in another embodiment of the present invention by changing the geometry of expansion portion 22 as shown in FIG. 7. In this embodiment, the tab 104 may not be supported by the recess 24 (as shown in FIGS. 2-4) but the distal ends of the prongs 20 may support the tab 104, for positioning the spring clip 10. As can be seen by comparing FIG. 4 with FIG. 7, the present invention may be used for clamping onto a tubular member 100 from any convenient direction. This may be useful if the expansion portion 22 or other portions of the spring clip 10 should not easily fit in the environment surrounding the tubular member 100.

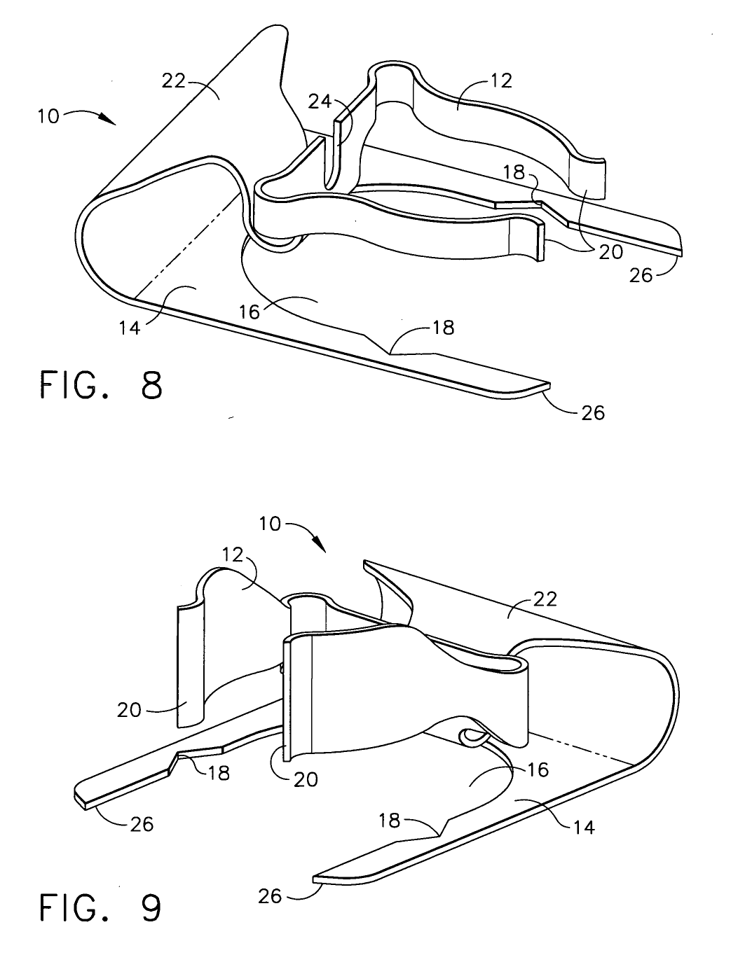

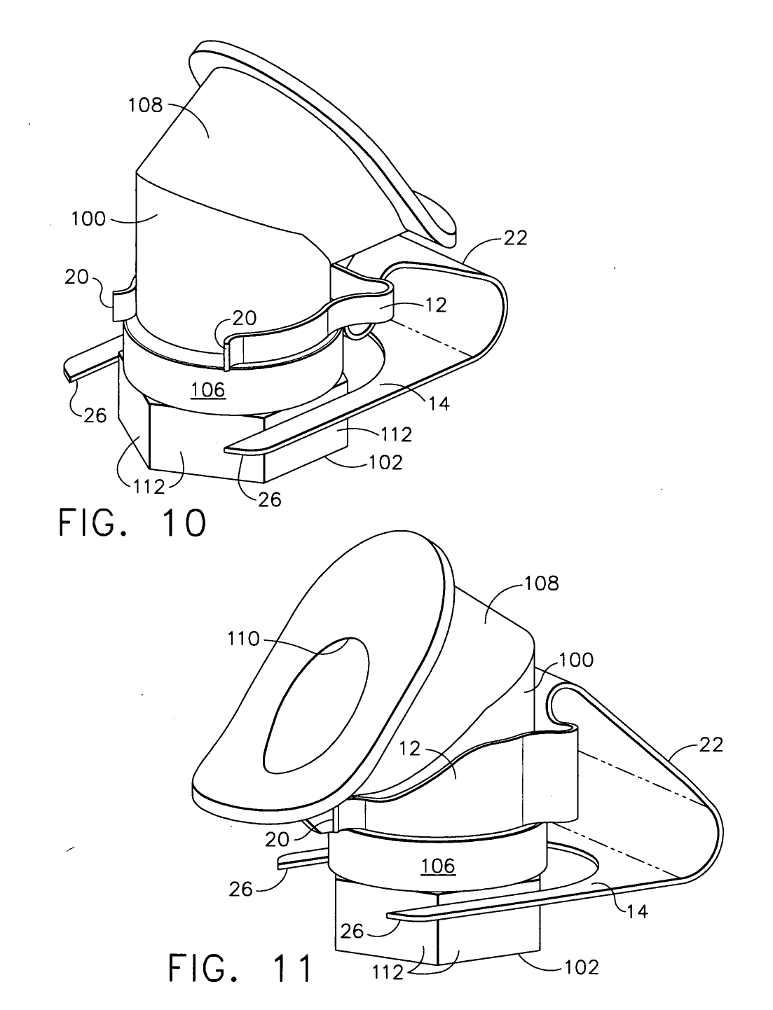

Still other embodiments of the present invention are shown in FIGS. 8, 9, 10, and 11. In FIG. 8, second arm 14 may comprise prongs 26, such as two prongs 26, as shown. FIG. 9 shows a spring clip 10, such as the spring clip 10 shown in FIG. 5, but with prongs 26 included within the second arm 14. The spring clips 10, shown in FIGS. 6 and 8, may be used in other embodiments of the present invention by using a second arm 14 that includes prongs 26, as shown in FIGS. 11 and 10, respectively. The spring clip 10 may be disengaged by pushing upwards on the prongs 26, towards boss 100, until the prongs 26 clear the head of fastener 102, and holding the prongs 26 in that position. At that time, the fastener 102 may be removed via normal means of removing a fastener. After the fastener 102 has been removed, the force on the prongs 26 may be backed off, returning the prongs 26 to a normal resting position.

A method of making an anti-rotation spring clip 10 may comprise providing a flat blank of resilient material, such as spring steel, having a first surface and an opposite second surface; stamping the blank to form a first arm 12, second arm 14, and an expansion portion 22 interconnecting the first arm 12 and the second arm 14; providing an aperture 16 in the second arm 14; and stamping a portion of the first arm 12 to form a plurality of prongs 20; bending the expansion portion 22 such that the first arm 12 and the second arm 14 are coaxial about a common axis A; and bending the expansion portion 22 into a curvilinear shape.

A method of preventing rotation of a fastener 102 may comprise clamping a first arm 12 around an outer surface 108 of a tubular member 100; mating a recess 24 in the first arm 12 with a tab 104 that projects radially outward from the tubular member 100; placing an aperture 16 in the second arm 14 around an outer surface 108 of the tubular member 100; and integrally connecting the first arm 12 with the second arm 14 with an expansion portion 22. The aperture 16 may be larger than the outer dimensions of a fastener 102.

A method of preventing the rotation of a fastener 102 threaded into a tubular member 100 may comprise using a spring clip 10 with the fastener 102. The spring clip 10 may include a first arm 12 and a second arm 14. The first arm 12 may include at least one prong 20. The second arm 14 may have an aperture 16, which may hover around the fastener 102. The first arm 12 and the second arm 14 may be connected together by an expansion portion 22. Thereafter, the method may include applying an external force to the fastener 102. The external force may have a tendency to unthread the fastener 102; wherein at least one side or corner 112 of the fastener 102 may abut against the aperture 16 (for example, at notch 18), thereby preventing rotation of the fastener 102 from the tubular member 100.

It should be understood, of course, that the foregoing relates to exemplary embodiments of the invention and that modifications may be made without departing from the spirit and scope of the invention as set forth in the following claims.

1. An anti-rotation apparatus, comprising:
a tubular member having an outer surface;
a threaded fastener having a polygonal shape mated with the tubular member; and
a spring clip having a first arm, a second arm, and a expansion portion interconnecting the first and second arms, the first arm having a least one prong and being connected to the outer surface of the tubular member, the second am having an aperture, the aperture having a maximum diameter that is greater than a maximum diameter of the threaded fastener, the expansion portion suspending the second arm such that the second arm is movable between an engaged, position and a disengaged position by applying a force on the second arm towards the first arm and when the second arm is in the engaged position, the aperture completely surrounds a periphery of the threaded fastener and at least a portion of the aperture cooperates with the fastener to restrict rotation of the threaded fastener relative to the tubular member.

2. The apparatus of claim 1, further comprising a trapezoidal or rectangular tab protruding radially outward from the tubular member, and wherein the first arm further comprises a recess mating with the tab.

3. The apparatus of claim 1, wherein the at least one prong clamps around at least a portion of the outer surface of the tubular member.

4. The apparatus of claim 1, wherein the spring clip is made from a single flat blank of resilient material.

5. The apparatus of claim 1, wherein the first arm comprises two prongs.

6. (canceled)

7. The apparatus of claim 1, where in the fastener is a threaded bolt, nut or plug.

8. An anti-rotation apparatus, comprising:
a tubular member with an outer surface and an inner surface;
a threaded fastener mated with the tubular member;
a tab protruding radially outward from the tubular member; and
a spring clip having a first arm, a second arm, and an expansion portion interconnecting the first and second arms, the first arm having a plurality of prongs and a recess, the prongs clamping around at least a portion of the outer surface of the tubular member and the recess mating with the tab to provide physical obstruction of the tab to prevent rotation of the said first arm relative to the tubular member, the second arm having an aperture, the aperture having a maximum diameter that is eater than a maximum diameter of the threaded fastener, the expansion portion suspending the second arm such that the second arm is moveable between an engaged position and a disengaged position by applying a force on the second arm towards the first arm and when the second arm is in the engaged position, the aperture completely surrounds a periphery of the threaded fastener and at least a portion of the aperture cooperates with the fastener to restrict rotation of the threaded fastener relative to the second arm.

9. The apparatus of claim 8, wherein said aperture includes at least one notch.

10. The apparatus of claim 8, wherein the tubular member is an oil drain boss.

11. The apparatus of claim 8, wherein the spring clip is comprised of a resilient material.

12. The apparatus of claim 11, wherein the spring clip is comprised of spring steel.

13. (canceled)

14. The apparatus of claim 8, wherein the threaded fastener is a bolt, nut, or plug.

15. An anti-rotation apparatus, comprising:
a tubular member with an outer surface and an inner surface;
a threaded fastener having a polygonal shape mated with the tubular member;
a seat situated coaxially on the outer surface of the tubular member;
a tab having opposite sides, the tab protruding radially outward from the tubular member; and
a spring clip having a first arm, a second arm, and an expansion portion interconnecting the first and second arms, the first arm having a plurality of prongs and a recess, the prongs clamping around at least a portion of the outer surface of the tubular member and the recess mating with the tab such that the recess opposes both sides of the tab to provide physical obstruction of the tab to prevent rotation of the said first arm relative to the tubular member, the second arm having an aperture with at least one notch, the aperture having a maximum diameter that is greater than a maximum diameter of the threaded fastener the expansion portion suspending the second arm such that the second arm is moveable between an engaged position and a disengaged position by applying a force on the second arm towards the first arm and when the second arm is in the engaged position, the aperture completely surrounds a periphery of the threaded fastener and the at least one notch cooperates with the fastener to restrict rotation of the threaded fastener relative to the second arm.

16. The apparatus of claim 15, wherein the aperture includes a plurality of notches.

17. The apparatus of claim 15, wherein the threaded fastener has a hexagonal shape.

18-19. (canceled)

20. The apparatus of claim 15, wherein the tab has a trapezoidal or rectangular shape.

21. The apparatus of claim 15, wherein the spring clip is comprised of spring steel.

22. (canceled)

23. The apparatus of claim 15, wherein the threaded fastener is a bolt, nut, or plug.

24-30. (canceled)

31. An anti-rotation apparatus for preventing rotation of an oil drain plug, comprising:
an oil drain boss with an outer surface and an inner surface;
a threaded fastener mated with the oil drain boss;
a seat situated coaxially on the oil drain boss;
a tab having opposite sides, the tab protruding radially outward from the oil drain boss; and
a spring clip having a first arm, a second arm, and an expansion portion interconnecting the first and second arms, the first arm having a plurality of prongs and a recess, the recess being oriented perpendicular to the plurality of prongs, the prongs clamping the tab and around at least a portion of the outer surface of the oil drain boss above the seat and the recess mating with the tab such that the recess surrounds both sides of the tab to provide physical obstruction of the tab to prevent rotation of the tab relative to said first arm the second arm having an with at least one notch, the aperture having a maximum diameter that is greater than a maximum diameter of the treaded fastener, the expansion portion including a curvilinear shape and suspending the second arm such that the second arm is moveable between an engaged position and a disengaged position by applying a force on the second arm towards the first arm and we the second arm is in the engaged position, the aperture completely surrounds a periphery of the threaded fastener and the at least one notch cooperates with the fastener to restrict rotation of the threaded fastener relative to the second arm.

32. The anti-rotation apparatus of claim 31, wherein the threaded fastener mates with the inner surface of the oil drain boss.

33. The anti-rotation apparatus of claim 31, wherein the first arm comprises two prongs.

34. (canceled)

35. The apparatus of claim 31, wherein the threaded fastener is a bolt, nut, or plug.

36. A method of preventing rotation of a headed fastener, comprising:
clamping a first arm around an outer surface of a tubular member;
mating a recess in the first arm with a tab that projects radially outward from the tubular member such that the tab is positioned in the recess to provide physical obstruction to movement of the tab relative to said first arm;
placing a second arm around an outer surface of a threaded fastener;
placing an aperture in the second arm around a periphery of the outer surface of the threaded fastener, the aperture being larger than the outer dimensions of the threaded fastener, and
integrally connecting the first arm with the second arm with an expansion portion.

37. The method of claim 36, wherein the first arm comprises a plurality of prongs.

38. The method of claim 36, wherein the first arm and the second arm are coaxial about a common axis.

39. A method of preventing the rotation of a threaded fastener threaded into a tubular member, comprising:
disposing a spring clip around the threaded fastener, wherein the tubular member includes a tab extending radially from the tubular member proximate the treaded fastener, the spring clip includes a first arm and second arm, the first arm including at least one prong and a recess, the recess mating with the tab such that the recess is positioned around the tab to physically restrict movement of the tab relative to the first arm, the second arm having an aperture, the aperture being larger than the outer dimensions of the threaded fastener and completely surrounding a periphery of the threaded fastener, and the first arm and second arm connected together by an expansion portion;
applying an external force to the threaded fastener, the external force having a tendency to unthread the threaded fastener; and
wherein at least one side of the threaded fastener abuts against the aperture thereby preventing rotation of the threaded fastener from the tubular member.

40. The method of claim 39, wherein the tubular member is an oil drain boss.
